(19) United States
(12) Patent Application Publication
(10) Pub. No.: US 2017/0294192 A1
(43) Pub. Date: Oct. 12, 2017

(54) Classifying Signals Using Mutual Information

(71) Applicant: KnuEdge Incorporated, San Diego, CA (US)

(72) Inventors: David C. Bradley, La Jolla, CA (US); Jeremy Semko, San Diego, CA (US); Sean O'Connor, San Diego, CA (US)

(21) Appl. No.: 15/480,113

(22) Filed: Apr. 5, 2017

Related U.S. Application Data
(60) Provisional application No. 62/320,227, filed on Apr. 8, 2016.

(51) Int. Cl. G10L 17/06; G10L 17/02; G10L 17/08

(52) U.S. Cl. CPC G10L 17/06; G10L 17/08; G10L 17/02

(57) ABSTRACT

Input data may be classified using one or both of mutual information between segments and expected class scores. Input data to be classified may be segmented into an input sequence of segments. The input sequence of segments may be compared with a reference sequences of segments for a first class to generate a first class score indicating a similarity between the input data and the first class. The first class score may be computed by computing a probability mass function between input segments and reference segments and then computing a mutual information value from the probability mass function. The input data may then be classified using the first class score and/or class score for other classes. In some implementations, expected class scores may be used in making the classification decision.

### CLAIM OF PRIORITY

This patent application claims the benefit of the following provisional patent application, which is hereby incorporated by reference in its entirety: U.S. Patent Application Ser. No. 62/320,227, filed on Apr. 8, 2016.

### BACKGROUND

Classification arises in a variety of applications. In performing classification, input data is received, and it is desired to determine to which of multiple classes the data most likely belongs. For example, a simple classification task may be to automatically determine whether a received email is spam or is not spam. When an email is received, information about the email (e.g. the text of the email, the sender, an internet protocol address of the sender) may be processed using algorithms and models to classify the email as spam or as not spam.

Another example of classification relates to determining the identity of a speaker. A class may exist for each speaker of a set of speakers, and a model for each class may be created by processing speech samples of each speaker. To perform classification, a received speech signal may be compared to models for each class. The received signal may be assigned to a class based on a best match between the received signal and the class models.

In some instances, it may be desired to verify the identity of a speaker. A speaker may assert his identity (e.g., by providing a user name) and a speech sample. A model for the asserted identity may be obtained, and the received speech signal may be compared to the model. The classification task may be to determine whether the speech sample corresponds to the asserted identity.

In some instances, it may be desired to determine the identity of an unknown speaker using a speech sample of the unknown speaker. The speaker may be unknown, but it may be likely that the speaker is of a known set of speakers (e.g., the members of a household). The speech sample may be compared to models for each class (e.g., a model for each person in the household), and the classification task may be to determine which class best matches the speech sample or that no class matches the speech sample.

When performing classification, it is desired that the classification techniques have a low error rate, and the classification techniques described herein may have lower error rates than existing techniques.

### BRIEF DESCRIPTION OF THE FIGURES

The invention and the following detailed description of certain embodiments thereof may be understood by reference to the following figures:

FIG. 1 is an example system for performing classification using mutual information between segments.

FIG. 2 is a spectrogram of a speech signal illustrating an example segmentation of the speech signal.

FIGS. 3A and 3B illustrate segmentations of input data and reference data for multiple classes, respectively.

FIGS. 4A and 4B are example systems for implementing speaker verification using a mutual information classifier.

FIG. 5 is a flowchart of an example process for classifying data using a mutual information classifier.

FIG. 6A is an example system for classifying data without using expected class scores.

FIG. 6B is an example system for classifying data using expected class scores.

FIG. 7 is a flowchart of an example process for classifying data using expected class scores.

FIG. 8 is an exemplary computing device that may be used to classify data using mutual information and/or expected class scores.

### DETAILED DESCRIPTION

Described herein are techniques for performing classification. Although the classification techniques described herein may be used for a wide variety of classification tasks, for clarity of presentation, an example classification task of text-dependent speaker verification will be used. With text-dependent speaker verification, a user may assert his identity (e.g., by providing a name, username, or identification number) and speak a previously determined prompt. By processing the speech of the user, it may be determined whether the user is who he claims to be. The classification techniques described herein, however, are not limited to speaker verification, not limited to classifying audio signals, and may be applied to any appropriate classification task.

### Example Classification System

Data to be classified may be broken up into portions or segments. A segment may represent a coherent portion of the data that is separated in some manner from other segments. For example, with speech, a segment may correspond to a portion of a speech signal where speech is present or where speech is phonated or voiced. FIG. 2 illustrates a spectrogram of a speech signal that has been broken up into segments 221-225 (separated by the vertical lines) where each segment corresponds to a phonated portion of the speech signal.

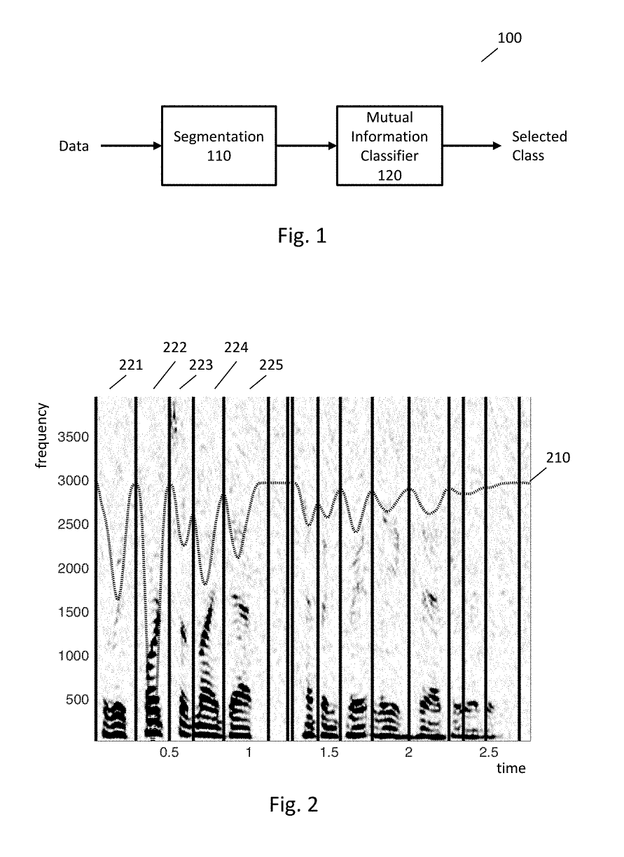

FIG. 1 illustrates a system 100 for classifying input data by obtaining segments from the input data and then processing the segments with a mutual information classifier to obtain a classification result.

FIG. 1 includes a segmentation component 110 that receives the input data and outputs an input sequence of segments corresponding to the input data. The segments output by segmentation component 110 may include any coherent portions of the input data or processed portions of the input data (such as feature vectors computed from a portion of a speech signal). In some implementations, each segment may correspond to a portion of a speech signal that is phonated, and these segments may be referred to as hyperphonemes. Segmentation is described in greater detail below.

FIG. 1 includes a mutual information classifier component 120 that receives the input sequence of segments and processes them to determine a classification decision. For example, mutual information classifier component 120 may compute a mutual information between each segment of the input sequence of segments and other segments that are known to correspond to particular classes. The mutual information values computed from the segments may then be used to determine the classification decision. Example implementations of a mutual information classifier are described in greater detail below.

### Segmentation

Further details of exemplary techniques for segmentation are now provided. Any appropriate types of segmentation may be used depending on the type of data being classified. A segment of a signal may be any portion of a signal that facilitates representation and/or processing of the signal. A segment of a signal may have a characteristic that is common to a portion of the signal corresponding to the segment but that characteristic may be different for portions of the signal adjacent to the segment. For example, for an image, a segment of the image may correspond to pixels representing an object in the image.

Where the data being classified is an audio signal, the signal may be segmented to any type of relevant audio unit. For example, where the signal is music, the signal may be segmented into individual notes, measures, or any other unit of music. Where the signal is speech, the signal may be segmented into speech vs. non-speech (e.g., the start of speech to end of speech with some threshold for intra-word gaps), syllables, phonemes, portions or combinations of phonemes, or any other unit of speech.

In some implementations, a speech signal may be segmented into a sequence of hyperphonemes. A hyperphoneme may correspond to any continuous portion of a speech signal that includes phonated speech. In some implementations, phonated speech may include only voiced speech (produced from vibrations of the vocal cords), and in some implementations, phonated speech may include both voiced speech and also other types of speech that includes oscillatory movement of the larynx, such as supra-glottal phonations.

Any appropriate techniques may be used to segment a speech signal, such as any of the techniques described in the following patent applications and patents, each of which are incorporated by reference in their entireties: U.S. patent application Ser. No. 15/372,205 filed on Dec. 7, 2016; U.S. patent application Ser. No. 15/181,868 filed on Jun. 14, 2016; U.S. patent application Ser. No. 15/181,878 filed in Jun. 14, 2016; U.S. Pat. No. 8,849,663 issued on Sep. 30, 2014; and U.S. Pat. No. 9,601,119 issued on Mar. 21, 2017.

In some implementations, segment boundaries may be determined by computing functions of the signal over time. The function of the signal may be computed at any appropriate time intervals. For example, a function of the signal may be computed at a time interval that is the same as the sampling rate of the signal. In some implementations, the function of the signal may be computed for successive frames of the signal. Frames of the signal may correspond to any sequence of portions of the signal, and frames may overlap one another. For example, frames may correspond to 50 millisecond portions of the signal at 10 millisecond intervals, and computing a function of such frames of the signal may provide function values at 10 millisecond intervals. The function used to process the signal for determining segment boundaries may be referred to as a stripe function.

Some stripe functions may be computed from a log likelihood ratio (LLR) spectrum of a frame of the signal. For a frame of a signal, let Xᵢ represent the value of the LLR spectrum and fᵢ represent the frequency corresponding to the value for i from 1 to N. Additional details regarding the computation of an LLR spectrum are described in U.S. Patent Application Publication No. 2016/0232906, filed on Dec. 15, 2015, which is hereby incorporated by reference in its entirety.

An example of a stripe function is the mean of the LLR spectrum and is denoted as KLD:

$$KLD = \frac{1}{N} {\sum }_{i = 1}^{N} {X}_{i}$$

Another example of a stripe function is the maximum value of the LLR spectrum and is denoted as MLP:

$$MLP = {max}_{i} {X}_{i}$$

Some stripe functions may be computed from a feature vectors computed from a frame of the signal. Any appropriate feature vector may be computed, such as a vector of harmonic amplitudes described in Patent Application Publication No. 2016/0232906. Let N be the number of harmonic amplitudes and mᵢ be the magnitude of the i^{th} harmonic for i from 1 to N. An example of a stripe function is as the harmonic energy density, denoted as harmonicEnergy and calculated as:

$$harmonicEnergy = \frac{1}{N} {\sum }_{i = 1}^{N} {m}_{i}^{2}$$

In some implementations, segment boundaries may be identified using the following combination of stripe functions:

c=−(KLD+MLP+harmonicEnergy)

For example, the function c may be computed at 10 millisecond intervals of the signal using the stripe functions as described above. In some implementations, the individual stripe functions (KLD, MLP, and harmonicEnergy) may be z-scored before being combined to compute the function c. The function c may then be smoothed by using any appropriate smoothing technique, such as Lowess smoothing. Each local peak of the function c may be determined to be a segment boundary. The segments may correspond to the portion of the signal before the first segment boundary, portions between any subsequent segment boundaries, and the portion after the last segment boundary.

FIG. 2 shows a spectrogram of a signal with the function c 210 superimposed on top of the spectrogram with a dashed line. Each local peak of the function c may correspond to a segment boundary as indicated by the vertical lines. The segments may correspond to the portions of the signal between the vertical lines, such as segments 221-225. In some implementations, these initial segments may be further refined as described in the Ser. Nos. 15/181,868 and 15/181,878 applications.

A segment of a signal may have a starting point and an ending point. For example, for an audio signal, the starting point and ending point of a segment may be specified by times (e.g., starting at 1.1 seconds and ending at 1.4 seconds), by an index of digital samples of the signal (e.g., from the 138^{th} sample to the 923^{rd} sample), or by an index of a sequence of frames (e.g., from the 10^{th} frame to the 36^{th} frame).

The data of the segment may include any appropriate representation of the signal. In some implementations, the segment may include one or more of the following: digital samples of the signal corresponding to the segment; a sequence of frequency representations of frames of the signal corresponding to the segment; a sequence of feature vectors (e.g., harmonic amplitude features) computed from frames of the signal corresponding to the segment; or any combination of the foregoing.

### Segment Class Data

When classifying an input signal, the signal may be classified as belonging to one of a known set of classes (or as not belonging to any of the classes). To determine which class the input signal corresponds to, segments of the input signal may be compared to example segments for each of the possible classes. Accordingly, to classify the input signal, example segments for each of the possible classes are needed.

For clarity of explanation, consider a text-dependent speaker verification application where a person asserts their identity (e.g., by specifying his or her name or identification number) and speaks a prompt that has been specified ahead of time (e.g., “open sesame”). An unknown person may assert that he is “John Smith” and speak the prompt. The received speech may be compared against known examples of the real John Smith speaking the prompt to verify that the unknown person is actually John Smith.

To verify a person, at least one example of the person speaking the prompt is needed to compare with the speech of the unknown person. Where there are multiple users of the speaker verification application, an example of each user speaking the prompt is needed to be able to verify each person. The process of obtaining an example of each user speaking the prompt may be referred to as enrolling the user in the speaker verification application. During the enrollment process, each user of the application may speak the prompt one or more times, and the enrollment speech may be processed and later used to verify the user.

Where classification is based on segments, the enrollment data may be segmented so that the segments of the enrollment data may later be compared segments obtained from an unknown user of the speaker verification application.

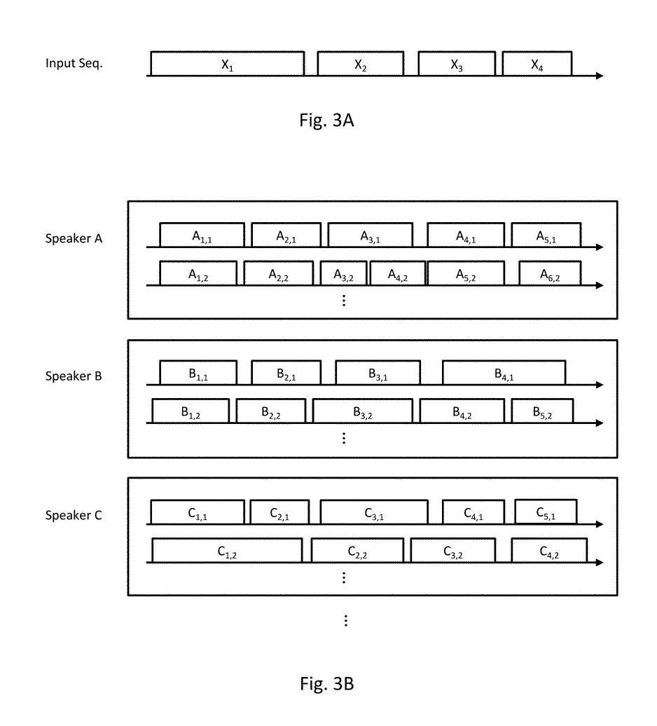

FIG. 3A illustrates a sequence of segments input data, such as may be obtained from an unknown user of a speaker verification application. The unknown user may speak the prompt, and the user's speech may be segmented using any of the techniques described above. The segments received from an unknown user may be referred to as an input sequence of segments and are denoted as X₁ . . . X₄ in FIG. 3A.

FIG. 3B illustrates sequences of segments corresponding to known classes of a classification application, such as a speaker verification application. In FIG. 3B, three classes are shown, a class for each of speaker A, speaker B, and speaker C. Each of the classes may have multiple sequences of segments, and each of the sequences of segments may correspond to a known example of the class. For example, for a speaker verification application, a class may correspond to a user of the application, and a class may include a first reference sequence of segments for a first example of the user speaking a prompt and a second reference sequence of segments for a second example of the same user speaking the prompt. Having multiple examples for a single user may improve the performance of the speaker verification application by accounting for natural variations in speech of the user.

The number of segments for the input sequence of segments and the reference sequences of segments for the classes need not have the same number of segments. Further, where a class has multiple reference sequences of segments, the multiple reference sequences for the class may have different numbers of segments. The different number of segments may account for different speaking styles of different users or natural variation in speaking style of a single user.

In the example of FIG. 3B, two reference sequences of segments are shown for each of speaker A, speaker B, and speaker C. Speaker A has a first sequence with 5 segments (A_{1,1} . . . A_{5,1}) and a second sequence (A_{1,2} . . . A_{6,2}) with 6 segments. Speaker B has a first sequence with 4 segments (B_{1,1} . . . B_{4,1}) and a second sequence (B_{1,2} . . . B_{5,2}) with 5 segments. Speaker C has a first sequence with 5 segments (C_{1,1} . . . C_{5,1}) and a second sequence (C_{1,2} . . . C_{4,2}) with 4 segments.

### Speaker Verification Classifier

Further details of exemplary techniques for performing speaker verification by computing mutual information values for segments of the input signal are now described.

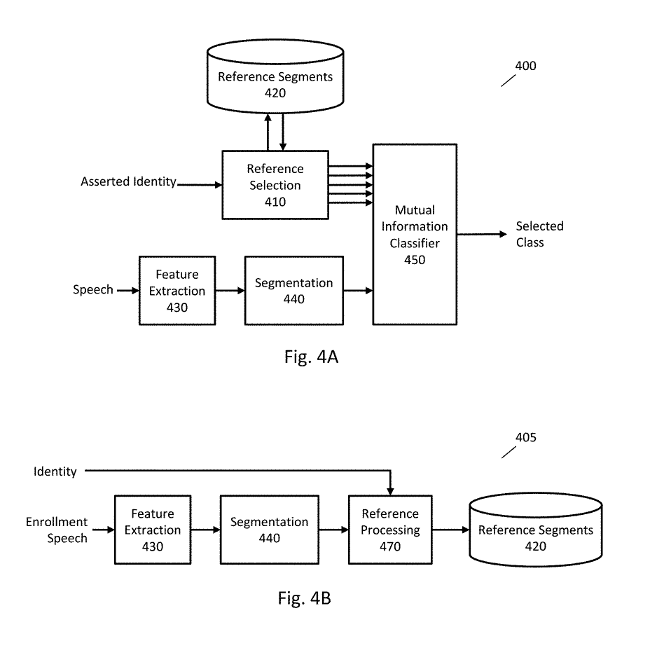

FIG. 4A shows an example of a system 400 that may be used for text-dependent speaker verification. A user provides an asserted identity and speaks a prompt. For example, the user may be authenticating himself on a smart phone, authenticating himself on a personal computer, or seeking access to a locked room. The classification may be performed on a single device (e.g., a smart phone or personal computer) or may be performed remotely by transmitting the asserted identity and an audio signal of the speech to a remote device, such as a server computer.

A received audio signal may be processed by a feature extraction component 430. For example, feature extraction component 430 may process the audio signal to generate feature vectors at regular time intervals, such as every 10 milliseconds. A feature vector may comprise harmonic amplitudes, mel-frequency cepstral coefficients, or any other suitable features.

As an example, a feature vector of harmonic amplitudes may include an estimate of an amplitude of each harmonic in a frame of the signal. For a frame of the audio signal, harmonic amplitudes may be computed as follows: (i) estimate a pitch of the frame of the signal (optionally using a fractional chirp rate); (ii) estimate an amplitude of each harmonic of the frame of the signal where the first harmonic is at the pitch, the second harmonic is at twice the pitch, and so forth; and (iii) construct a vector of the estimated amplitudes. This process may be repeated for subsequent frames. For example, for a first frame at a first time, a first pitch may be estimated and then amplitudes of the harmonics may be estimated from the frame using the pitch. A first feature vector for the first frame may be constructed as [a_{1,1} a_{1,2} . . . a_{1,M}] where a_{1,j} indicates the amplitude of the j^{th} harmonic of the first frame for j from 1 to M. Similarly, a second feature vector for a second frame at a second time may be constructed as [a_{2,1} a_{2,2} . . . a_{2,M}], and so forth. Collectively, the feature vectors may be referred to as a sequence of feature vectors. Additional details regarding the computation of harmonic amplitude features are described in Patent Application Publication No. 2016/0232906.

Feature extraction component 430 may output a sequence of feature vectors that may then be processed by segmentation component 440. Segmentation component 440 may create an input sequence of segments from the sequence of feature vectors. A segment of the input sequence may comprise a portion or subset of the sequence of feature vectors. For example, a sequence of feature vectors produced by feature extraction component 430 may comprise 100 feature vectors, and segmentation component 440 may identify a first segment the corresponds to feature vectors 11 to 42, a second segment that corresponds to feature vectors 43 to 59, and a third segment that corresponds to feature vectors 75 to 97. Collectively, the segments identified by segmentation component 440 may be referred to an input sequence of segments, and each segment corresponds to a portion or subset of the sequence of feature vectors. Segmentation component 440 may use any segmentation techniques described above and may receive additional inputs, such as the signal, frames of the signal, or frequency representations of frames of the signal.

Reference selection component 410 may receive an asserted identity of the user and may retrieve a plurality of reference sequences of segments from reference segments data store 420. For example, reference segments data store 420 may include reference sequences of segments that were created when users enroll with the speaker verification application, such as the reference sequences of segments of FIG. 3B.

Mutual information classifier component 450 receives the input sequence of segments from segmentation component 440 and receives one or more reference sequences of segments from reference selection component 410 and makes a classification decision by computing mutual information values between pairs of segments as described in greater detail below. Mutual information classifier component 450 may also use other reference sequences of segments in making a classification decision. For example, mutual information classifier component 450 may receive and use reference sequences of segments corresponding to users other than the asserted identity. Mutual information classifier component 450 may output a result, such as whether the user's speech matches the asserted identity.

FIG. 4B shows an example of a system 405 that may be used for generating reference sequences of segments that may be used with system 400 of FIG. 4A. In FIG. 4B, a user provides an identity and enrollment speech. In some implementations, other procedures may be taken to ensure that the identity is correct, such as requiring the user to provide identification. The enrollment speech may comprise one or more instances of the user speaking a prompt. The enrollment speech may be processed with feature extraction component 430 and segmentation component 440 (which may perform the same or similar processing as the corresponding components of FIG. 4A). Reference processing component 470 may receive a reference sequence of segments for each example of the user speaking the prompt. Reference processing component 470 may store the reference sequences of segments in reference segments data store 420 in association with the identity of the user so that they may later be retrieved by reference selection component 410.

The techniques described above may straightforwardly be applied to other speaker recognition tasks, such as text-independent speaker verification or passive speaker identification. The techniques described above may also be applied to any other appropriate classification task, such as classifying emails as spam or not spam.

### Mutual Information Classifier

Input data may be classified by computing mutual information values between segments of input data and segments of reference data corresponding to one or more classes. For clarity in the presentation, the mutual-information classifier will be described using an example of text-dependent speaker verification, but the mutual-information classifier is not limited to speaker verification or to classifying audio signals, and may be applied to any appropriate classification task. For example, the mutual information classifier may be used for other types of speaker recognition (e.g., text independent, active, passive), for speech recognition, and for processing images or video.

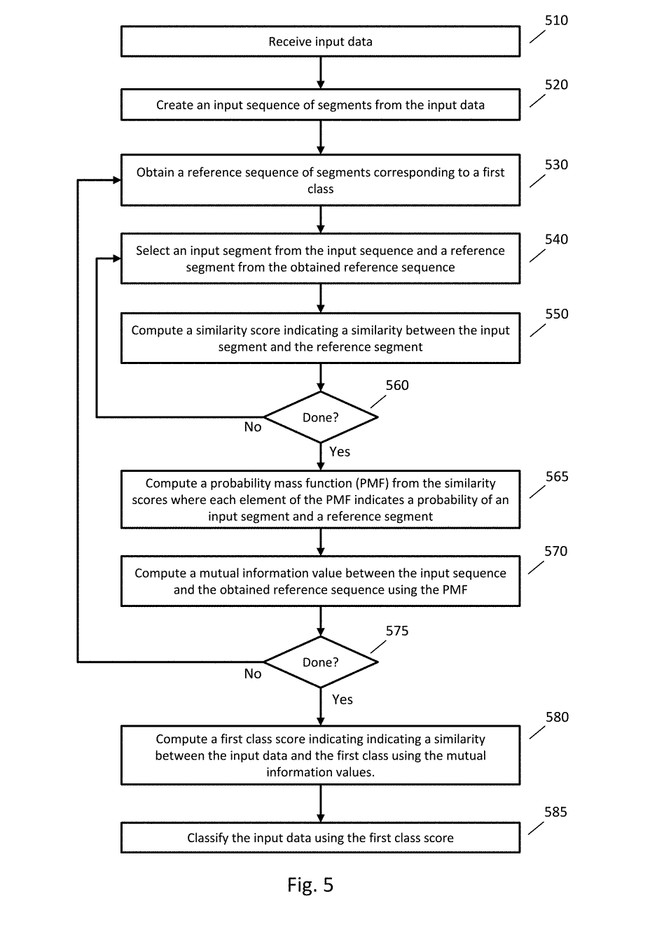

FIG. 5 is a flowchart illustrating an example implementation of classifying input data using mutual information between segments. In FIG. 5, the ordering of the steps is exemplary and other orders are possible, not all steps are required and, in some implementations, some steps may be omitted or other steps may be added. The process of the flowcharts may be implemented, for example, by one or more computers, such as the computers described below or of the system 400 of FIG. 4A.

At step 510, input data is received for classification. In some implementations, input audio data and an asserted identity may be received from a user of the speaker verification application. For example, the asserted identity may comprise any data that indicates the identity of a person (such as a user name or an identification number), and the audio data may be any data that represents speech of the user (such as an audio signal or a sequence of feature vectors computed from an audio signal).

At step 520, an input sequence of segments is created from the input data. Any appropriate segmentation techniques may be used to create the input sequence of segments, such as any of the segmentation techniques described above. FIG. 3A illustrates an example of an input sequence of segments where Xⱼ represents the j^{th} input segment of the input sequence of segments.

At step 530, a reference sequence of segments corresponding to a first class is obtained. The reference sequence of segments may have been created from data corresponding to the class using any appropriate segmentation techniques, such as any of the segmentation techniques described above. FIG. 3B illustrates examples of reference sequences of segments for several classes. In some implementations, the reference sequences of segments may be selected corresponding to an asserted identity of a user of a speaker verification application. For example, the reference sequences of segments may be obtained by performing a database lookup using the asserted identity. The reference sequences of segments may have been generated, for example, when a user enrolled in a speaker verification application. The reference sequences of segments may have been generated during the enrollment process or may be generated at a later time, such as immediately prior to performing a speaker verification procedure.

At steps 540 to 560, an input segment of the input sequence of segments and a reference segment of the reference sequence of segments are processed. The processing of an input segment and a reference segment in steps 540 to 560 may be referred to as an iteration and any number of iterations may occur. In some implementations, an iteration may occur for every pairwise combination of an input segment and a reference segment. For example, if there are N input segments and M reference segments, then there may be a total of N times M iterations, each with a different combination of an input segment and a reference segment. Such iterations may be performed using two nested loops. The pairs of segments may be processed in any order and may be processed in parallel.

At step 540 an input segment and a reference segment are selected. For example, for a first iteration, the first segment of the input sequence and the first segment of the reference sequence may be selected. For other iterations, other pairs of input and reference segments may be selected.

At step 550, a similarity score is computed indicating a similarity between the input segment and the reference segment. Any appropriate techniques may be used to generate the similarity score. Examples of computing similarity scores are now described, but the techniques described herein are not limited to the following examples.

In some implementations, the similarity score may be a Pearson's product-moment correlation between an input segment and a reference segment. Let X represent an input segment and A represent a reference segment. Each segment may comprise a sequence of feature vectors and each feature vector may comprise a vector of feature values. For now, we will assume that the input segment and the reference segment each have the same length (the same number of feature vectors), and segments of different lengths are addressed below. Where a segment comprises a sequence of N feature vectors and a feature vector comprises M feature values, the segment has a total of N times M feature values. The feature values for the input segment X may be reformulated as a first vector and referred to as xᵢ where i ranges from 1 to N times M. Similarly, the feature values for reference segment A may be reformulated as a second vector and referred to as aᵢ where i ranges from 1 to N times M. The Pearson's product-moment correlation of segments X and A may be computed using the reformulated first vector and the second vector as

$$r = \frac{{Σ}_{i = 1}^{NM} ( {x}_{i} - \overline{x} ) ( {a}_{i} - \overline{a} )}{( NM - 1 ) {σ}_{x} {σ}_{a}}$$

where \tilde{x} is the sample mean of the xᵢ, σₓ is the sample standard deviation of the xᵢ, ā is the sample mean of the aᵢ, and σₐ is the sample standard deviation of the aᵢ.

In computing the Pearson's product-moment correlation of two segments, the two segments need to have the same length (e.g., the same number of feature vectors). Any appropriate techniques may be used to modify the length of a segment so that it matches the length of another segment. For example, to increase the length of a segment, (i) feature vectors that occurred before or after the segment may be added to the beginning or end of the segment, (ii) the first or last feature vector of a segment may be repeated, or (iii) feature vectors of zeros may be added to the beginning or end of a segment. To decrease the length of a segment, feature vectors from the beginning or end of the segment may be discarded. Either or both of the input segment and the reference segment may be modified so that the two segments have the same length.

In some implementations, either the input segment or the reference segment may be shifted relative to the other segment (e.g., in time) before computing the Pearson's product-moment correlation of the segments. The techniques used to shift a segment may include any of the techniques above to modify the length of a segment to have the same length as the other segment. Any appropriate technique may be used to determine which segment to shift and the relative amount of the shift between the two segments.

In some implementations, Pearson's product-moment correlation may be computed for multiple relative shifts of the two segments. For example, the shift of the input segment relative to the reference segment may range from −20 to 20 (e.g., shifts in the feature vectors that make of the segment), and a Pearson's product-moment correlation may be computed for each of the shifts. The similarity score for an input segment and a reference segment may correspond to the largest value of the Pearson's product-moment correlation computed for all of the shifts.

In some implementations, the Pearson's product-moment correlation may be replaced with a different type of correlation, and the techniques described herein are not limited to a Pearson's product-moment correlation. The similarity core may include any computation that indicates a statistical dependence between the two segments. For example, the similarity score may be any of a Pearson's product-moment coefficient, a rank correlation coefficient, a Spearman's rank correlation coefficient, a Kendall's rank correlation coefficient, a distance correlation, a Brownian correlation, a randomized dependence coefficient, a correlation ratio, mutual information, a total correlation, a dual total correlation, a polychoric correlation, or a coefficient of determination.

In some implementations, the similarity score of step 550 may be any of the correlations described above. In some implementations, the similarity score of step 550 may be a processed version of any of the correlations described above.

In some implementations, the similarity score may be a Fisher transform of a correlation computed as

$$φ = \frac{1}{2} log ( \frac{1 + r}{1 - r} )$$

where r represents any correlation of an input and a reference segment as described above.

In some implementations, the similarity score may be a transformation of a correlation (or a further transformation of a Fisher transform of a correlation) using a cumulative distribution function (CDF) so that the similarity score is in the range of 0 to 1. Any appropriate CDF may be used to transform a correlation, such as a CDF that is estimated using correlations computed from reference sequences of segments, such as the reference sequences in FIG. 3B.

In some implementations, a correlation may be computed for each pair of segments of the reference sequences of segments, and an empirical CDF may be computed from all of the correlation values. For example, an empirical CDF for a value of w, may be computed as the number of computed correlations less than or equal to w divided by the total number of correlations. The empirical CDF may be a stepwise function or smoothed to create a smooth function.

In some implementations, an empirical CDF may be computed using only matching segments for each class. Suppose that a class has N reference sequences of segments. A first segment in a first reference sequence of segment will have one matching segment in each of the other reference sequences of segments for the class or N−1 matching segments. The matching of segments may be performed manually or may be done automatically by selecting a matching segment from a reference sequence of segments as the segment that has a highest correlation with the segment being matched. Correlations may be computed for all matching segments of all classes, and an empirical CDF may be computed from these correlations.

In some implementations, the CDF may be assumed to have a parametric form, such as a CDF of a Gaussian random variable that is specified by a mean and a variance. The correlations computed from the reference sequences of segments (e.g., all of the correlations, correlations from matching segments, or any other set of correlations) may then be used to estimate the parameters of the CDF.

The CDF may be the same for each iteration of steps 540 to 560 or may be different. The CDF may be computed ahead of time and accessed as needed for each iteration of steps 540 to 560.

The similarity score computed at step 550 may be any score that indicates a similarity between the input segment and the reference segment. In some implementations, the similarity score may be a correlation of the input segment and the reference segment (e.g., a Pearson's product-moment correlation), a Fisher transform of a correlation, a CDF transform of a correlation, or a CDF transform of a Fisher transform of a correlation.

At step 560, it is determined whether other combinations of an input segment and a reference segment remain to be processed. If other combinations remain to be processed, processing proceeds to step 540 where another combination of an input segment and a reference segment is selected. If no other combinations remain to be processed, processing proceeds to step 565.

At step 565, a similarity score has been computed for combinations of input segments and reference segments. In some implementations, these similarity scores may be represented as a matrix where the number of rows of the matrix is equal to the number of input segments in the input sequence of segments and the number of columns is equal to the number of reference segments in the reference sequence of segments (or vice versa). Each element of the matrix is a similarity score for the input sequence corresponding to the row of the matrix and the reference sequence corresponding to the column of the matrix.

At step 565, a probability mass function (PMF) may be computed using the similarity scores. The PMF may be a joint PMF between input segments and reference segments, a conditional PMF of input segments given a reference segment, a conditional PMF of reference segments given an input segment, or any other appropriate PMF.

In some implementations, a joint PMF may be computed as a matrix where each element of the matrix indicates a joint probability of an input segment and a reference segment. The joint PMF matrix may be computed by normalizing a matrix of similarity scores such that the matrix sums to 1. For example, let s_{i,j} represent a similarity score of input segment i of the input sequence of segments and reference segment j of the reference sequence of segments. A joint PMF may be computed as

$${P}_{X , Y} ( i , j ) = \frac{{s}_{i , j}}{{\sum }_{k = 1}^{M} {\sum }_{l = 1}^{N} {s}_{k , l}}$$

where there are M input segments and N reference segments.

In some implementations, a conditional PMF may be computed as a matrix where each element of the matrix indicates a conditional probability of an input segment given a reference segment. The conditional PMF matrix may be computed by normalizing each column of the matrix of similarity scores such that each column sums to 1. For example, a conditional PMF may be computed as

$${P}_{X \vert Y} ( i \vert j ) = \frac{{s}_{i , j}}{{\sum }_{k = 1}^{M} {s}_{k , j}}$$

In some implementations, a conditional PMF may be computed as a matrix where each element of the matrix indicates a conditional probability of a reference segment given an input segment. The conditional PMF matrix may be computed by normalizing each row of the matrix of similarity scores such that each row sums to 1. For example, a conditional PMF may be computed as

$${P}_{Y \vert X} ( j \vert i ) = \frac{{s}_{i , j}}{{\sum }_{k = 1}^{N} {s}_{i , k}}$$

At step 570, a mutual information value between the input sequence and the reference sequence is computed using the PMF computed at step 565. The mutual information value may be computed using any appropriate techniques. For example, where the PMF is a joint PMF, the mutual information may be computed as

$${P}_{X} ( i ) = {\sum }_{j = 1}^{N} {P}_{X , Y} ( i , j )$$

$${P}_{Y} ( j ) = {\sum }_{i = 1}^{M} {P}_{X , Y} ( i , j )$$

$$I ( X , Y ) = {\sum }_{i = 1}^{M} {\sum }_{j = 1}^{N} {P}_{X , Y} ( i , j ) log ( \frac{{P}_{X , Y} ( i , j )}{{P}_{X} ( i ) {P}_{Y} ( j )} )$$

Where the PMF is a conditional PMF where each element indicates a conditional probability of an input segment given a reference segment, the mutual information may be computed as

$${P}_{X} ( i ) = {\sum }_{j = 1}^{N} \frac{{P}_{X \vert Y} ( i \vert j )}{N}$$

$${P}_{Y} ( j ) = \frac{1}{N}$$

$$I ( X , Y ) = {\sum }_{j = 1}^{N} {P}_{Y} ( j ) = {\sum }_{i = 1}^{M} {P}_{X \vert Y} ( i \vert j ) log ( \frac{{P}_{X \vert Y} ( i \vert j )}{{P}_{X} ( i )} )$$

In some implementations, the marginal probabilities, P_{Y}(j), may be selected in other ways. For example, the marginal probability for a reference segment may relate to a relative length of a reference segment as compared to the lengths of other reference segments.

Where the PMF is a conditional PMF where each element indicates a conditional probability of a reference segment given an input segment, the mutual information may be computed as

$${P}_{X} ( i ) = \frac{1}{M}$$

$${P}_{Y} ( j ) = {\sum }_{i = 1}^{M} ( \frac{{P}_{Y \vert X} ( j \vert i )}{M} )$$

$$I ( X , Y ) = {\sum }_{i = 1}^{M} {P}_{X} ( i ) = {\sum }_{j = 1}^{N} {P}_{Y \vert X} ( j \vert i ) log ( \frac{{P}_{Y \vert X} ( j \vert i )}{{P}_{Y} ( j )} )$$

In some implementations, the marginal probabilities, P_{X}(i), may be selected in other ways, such as indicated above.

Step 570 is not limited to computing a mutual information from a PMF function as described above. In some implementations, step 570 may compute a different value from a PMF that indicates a similarity between the input sequence of segments and the reference sequence of segments. For example, step 570 may compute any of the following from a PMF (either joint or conditional): the variation of information distance metric, the Jaccard distance, conditional mutual information, directed information, normalized mutual information (e.g., by entropy of marginal or joint entropy of X and Y), weighted mutual information, adjusted mutual information, absolute mutual information, Pearson's chi-squared statistics, or G-test statistics.

At step 575, it is determined whether other reference sequences of segments for the first class remain to be processed. If other reference sequences remain to be processed, processing proceeds to step 530 where another reference sequence is obtained. If no other reference sequences remain to be processed, processing proceeds to step 580.

At step 580, a first class score is computed that indicates a similarity between the input data and the first class using the mutual information values computed at step 570. At step 570 a mutual information value is computed for each reference sequence of segments. The first class score may be any combination of the mutual information values, such as an average of the mutual information values.

Steps 530 to 580 computed a first class score that indicates a similarity between the input data and the first class using reference sequences corresponding to the first class. These steps may similarly be repeated for other classes. For example, a second class score may be computed that indicates a similarity between the input data and a second class using reference sequences corresponding to the second class, a third class score may be computed that indicates a similarity between the input data and a third class using reference sequences corresponding to the third class, and so forth.

At step 585, a classification decision is made using the first class score. In some implementations, the first class score may be compared to a threshold to determine if the input data corresponds to the first class. In some implementations, a plurality of class scores may be computed that include the first class score and the second and third class scores described above. The input data may be classified by selecting a highest class score of the plurality of class scores.

The above process may be applied to text-dependent speaker verification. An unknown user may assert an identity and speak a prompt. An input sequence of segments may be created from the speech of the prompt, and reference sequences of segments may be obtained that correspond to the asserted identity (e.g., created during an enrollment process). A mutual information value may be created by comparing the input sequence of segments with each of the reference sequence of segments, as described above. A class score may be computed by combining the mutual information values (e.g., averaging them). The unknown person may be verified by comparing the class score to a threshold and/or comparing it with class scores computed for other users of the speaker verification application.

### Vectors of Expected Class Scores

Now described is another classification technique that may be combined with the mutual information classifier described above or combined with other classifiers. This classification technique makes a classification decision using a vector of expected class scores for each class.

For clarity of presentation, an example classification task with five classes is presented. For example, a speaker verification application with five enrolled speakers. The input data to be classified is denoted as X and the five classes are denoted with the letters A to E. For each of the five classes, reference data is available corresponding to examples of each of the classes. Each class may have multiple examples of reference data. For example, for a speaker verification application, the input data may be speech of an unknown person speaking a prompt, and the reference data for each class may be examples of a person corresponding to the class speaking the prompt.

Each of the classes may have a different number of examples of reference data. The number of examples for each class is denoted as N_{A} for class A, N_{B} for class B, and so forth. The examples of class A are denoted as Aᵢ for i from 1 to N_{A}, the examples of class B are denoted as Bᵢ for i from 1 to N_{B}, and so forth. Below, it will be convenient to refer to all the reference data for a class, and the reference data for class A (Aᵢ for i from 1 to N_{A}) is denoted as Ā, the reference data for class B is denoted as B̅, and so forth.

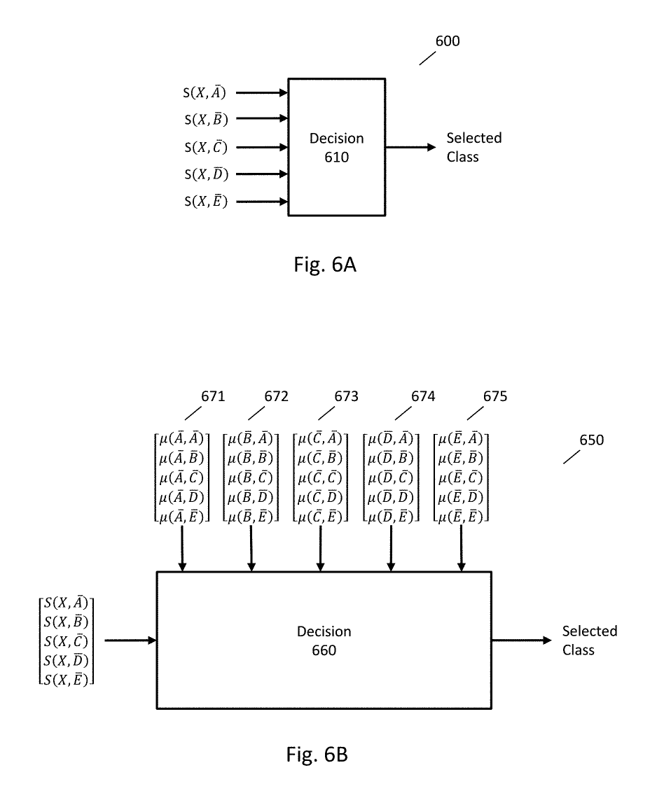

FIG. 6A illustrates a system 600 for classifying input data that does not use vectors of expected class scores. In FIG. 6A, input data X is received, and a class score is computed that indicates a similarity between the input data and the reference data for each of the classes. The class score indicating a similarity between X and the reference data for class A is denoted as S(X, Ā), the class score indicating a similarity between X and the reference data for class B is denoted as S(X, B̅), and so forth. For example, for the mutual information classifier, these class scores may be computed as described at step 580 of FIG. 5.

Decision component 610 may receive the class scores and make a classification decision to output a result of the classification. Decision component 610 may apply any appropriate techniques for making a classification decision, such as selecting a class corresponding to a highest class score.

FIG. 6B illustrates a system 650 for classifying input data that uses vectors of expected class scores. As used herein, the “expected” in expected class scores does not refer to expected values of random variables but instead refers to observed class scores computed from the reference data for the classes. Decision component 660 of FIG. 6B receives the same input as decision component 610 of FIG. 6A (although it may be formulated as a vector instead of individual values), but makes the classification decision using vectors of expected class scores 671-675 for each class. The vector of expected class scores for class A is indicated by 671, the vector of expected class scores for class B is indicated by 672, and so forth.

Suppose that the input data X corresponds to class A. We expect the class score for A, denoted as S(X, Ā), to be higher than the class scores for the other classes. But other information is also available for making the classification decision. Where the input data X corresponds to class A, the class scores for the other classes will be generally be lower than the class score for A, but the class scores for the other classes may follow a pattern that can be used to improve the classification decision.

For example, for a speaker verification application, suppose that class A corresponds to a 60-year-old man, class B corresponds to a 55-year-old man, class C corresponds to 30-year-old man, class D corresponds to a 40-year-old woman, and class E corresponds to a 5-year-old girl. Based on the ages and genders of the classes, one might expect that when the input data X corresponds to class A, that the class score for B, denoted as S(X, B̅), will be relatively high (because the genders are the same and the ages are close) and the class score for E, denoted as S(X, Ē), will be relatively low (because the genders are different and a 50-year age difference) with the other class scores somewhere in between. Because patterns in the class scores are expected, a vector of expected class scores may be created for each class, and these vectors of expected class scores may be used in making the classification decision.

The vectors of expected class scores may be created using the reference data for the classes. Let μ(Ā, B̅) denote an expected class score for class B when the input data X corresponds to class A. This expected class score may be computed from the reference data:

$$μ ( \overline{A} , \overline{B} ) = \frac{1}{{N}_{A}} {\sum }_{i = 1}^{{N}_{A}} S ( {A}_{i} , \overline{B} )$$

where S(Aᵢ, B̅) represents any appropriate technique for computing a class score indicating a similarity between input data (here, Aᵢ) and a class (here, class B). For example, the class score may be computed as described at step 580 of FIG. 5

Similarly, let μ(Ā, Ā) denote an expected class score for class A when the input data X corresponds to class A, let μ(Ā, C̅) denote an expected class score for class C when the input data X corresponds to class A, and so forth. Accordingly, a vector of expected class scores when the input data corresponds to class A may be computed as

$${μ}_{A} = [ \begin{matrix}μ ( \overline{A} , \overline{A} ) \\ μ ( \overline{A} , \overline{B} ) \\ μ ( \overline{A} , \overline{C} ) \\ μ ( \overline{A} , \overline{D} ) \\ μ ( \overline{A} , \overline{E} )\end{matrix} ]$$

In some implementations, an expected class score for a class when the input data X corresponds to the same class may be computed differently to avoid comparing a class example against itself. Comparing a class example against itself may produce very different values when comparing a class example against another example of the same class. Comparing a class example with another example of the same class may be more relevant since the input data is presumably not the same as the class examples. Accordingly, an expected class score for a class when the input data X corresponds to the same class may be computed as:

$$μ ( \overline{A} , \overline{A} ) = \frac{1}{{N}_{A}} {\sum }_{i = 1}^{{N}_{A}} S ( {A}_{i} , {{A}_{i}}^{=} )$$

where A̅ᵢ indicates all the reference data for class A except Aᵢ.

Similarly, vectors of expected class score may be computed for the input data corresponding to other classes. For example, a vector of expected class scores when the input data corresponds to class B may be computed as

$${μ}_{B} = [ \begin{matrix}μ ( \overline{B} , \overline{A} ) \\ μ ( \overline{B} , \overline{B} ) \\ μ ( \overline{B} , \overline{C} ) \\ μ ( \overline{B} , \overline{D} ) \\ μ ( \overline{B} , \overline{E} )\end{matrix} ]$$

The vectors of expected class scores for each class may be computed in advance using the reference data for the classes. These vectors of expected class scores may then be stored such that they may be used by decision component 660 in making a classification decision.

Decision component 660 may receive an input vector of class scores computed from input data X, such as a vector of the form

$${S}_{X} = [ \begin{matrix}S ( X , \overline{A} ) \\ S ( X , \overline{B} ) \\ S ( X , \overline{C} ) \\ S ( X , \overline{D} ) \\ S ( X , \overline{E} )\end{matrix} ]$$

Decision component 660 may be configured to compare the input vector of class scores S_{X} with each of the vectors of expected class scores (μ_{A} to μ_{E}) to make a classification decision. Any appropriate techniques may be used to compare the vector of class scores with the vectors of expected class scores, such as computing a cosine similarity or cosine distance between the vectors. Decision component 660 may be configured to make a classification decision by selecting a class whose vector of expected class scores is most similar to the input vector of class scores.

In some implementations, decision component 660 may be configured to use one or more other parameters representing a distribution of the class scores in making a classification decision. For example, a standard deviation or variance of the class scores may be computed and used by decision component 660 in making a classification decision. Let σ(Ā, B̅) denote a standard deviation of class scores for class B when the input data X corresponds to class A. This standard deviation may be computed from the reference data as:

$$σ ( \overline{A} , \overline{B} ) = \sqrt{\frac{1}{{N}_{A}} {\sum }_{i = 1}^{{N}_{A}} {( S ( {A}_{i} , \overline{B} ) - μ ( \overline{A} , \overline{B} ) )}^{2}}$$

where S(Aᵢ, B̅) represents any appropriate technique for computing a class score indicating a similarity between input data (here, Aᵢ) and a class (here, class B) and μ(Ā, B̅) is the expected class score for class B when the input data X corresponds to class A. Any appropriate method for determining a standard deviation may be used, such as an unbiased estimate that uses N_{A}−1 in the denominator instead of N_{A}. In some implementations, a standard deviation for a class when the input data X corresponds to the same class may be computed differently as indicated above.

This process may be repeated for other classes, and a vector of standard deviations of class scores when the input data corresponds to class A may be computed as

$${σ}_{A} = [ \begin{matrix}σ ( \overline{A} , \overline{A} ) \\ σ ( \overline{A} , \overline{B} ) \\ σ ( \overline{A} , \overline{C} ) \\ σ ( \overline{A} , \overline{D} ) \\ σ ( \overline{A} , \overline{E} )\end{matrix} ]$$

Decision component 660 may be configured to use a vector of expected class scores and a vector of standard deviations of class scores for each class in making a classification decision. In some implementations, the class scores may be modelled as having been generated by a Gaussian random variable and a likelihood may be computed for each class that indicates a likelihood that the input data corresponds to the class. The likelihood of class A given class scores computed for input data X (denoted as S_{X}) may be computed as

$$L ( A ; X ) = {\prod }_{i = 1}^{5} \frac{1}{\sqrt{2 {πσ}_{A} ( i )}} {e}^{- \frac{1}{2} {( \frac{{S}_{X} ( i ) - {μ}_{A} ( i )}{{σ}_{A} ( i )} )}^{2}}$$

where (i) indicates the i^{th} element of a vector. Similarly, a likelihood for class B, denoted as L(B; S_{X}), may be computed and so forth. Decision component 660 may be configured to compute a likelihood for each class and make a classification decision using the likelihoods, such as selecting a class with the largest likelihood.

Other variations of the above techniques are possible. In some implementations, the number of reference data examples may not be large enough to reliably estimate a vector of standard deviations of class scores for each class. Instead a single standard deviation may be computed for all classes, and the likelihood of class A given class scores computed for input data X may be computed as

$$L ( A ; X ) = {\prod }_{i = 1}^{5} \frac{1}{\sqrt{2 πσ}} {e}^{- \frac{1}{2} {( \frac{{S}_{X} ( i ) - {μ}_{A} ( i )}{σ} )}^{2}}$$

In some implementations, the number of reference data examples may be large enough that a full covariance matrix may be computed for each of the classes and a likelihood value for each class may be computed using a full covariance matrix. Any appropriate variation of computing variances and/or covariances may be used.

Decision component 660 may be configured to use any other classification techniques in making a classification decision. For example, decision component 660 may use logistic regression techniques for determining thresholds for making classification decisions and/or for determining corresponding error rates for chosen thresholds.

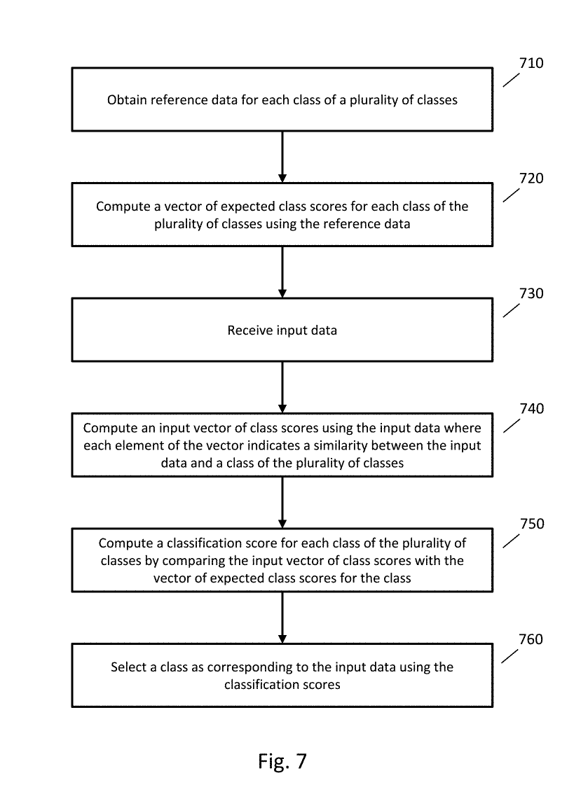

FIG. 7 is a flowchart illustrating an example implementation of classifying data using vectors of expected class scores. In FIG. 7, the ordering of the steps is exemplary and other orders are possible, not all steps are required and, in some implementations, some steps may be omitted or other steps may be added. The process of the flowcharts may be implemented, for example, by one or more computers, such as the computers described below or of the system 400 of FIG. 4A.

At step 710, reference data is obtained for each class of a plurality of classes. The classes may correspond to any appropriate classification task, such as speaker verification. The reference data for a class may include one or more examples of data corresponding to the class. For example, for text dependent speaker verification, the reference data may include one or more examples of a person speaking a prompt.

At step 720, a vector of expected class scores is computed for each class of the plurality of classes. The vector of expected class scores may be computed using any of the techniques described above. For example, a class score vector may be computed for each example of the reference data where each element of the vector indicates a similarity between the example of the reference data and a class of the plurality of classes. The class score vectors may be computed using any appropriate techniques, such as the scores computed at step 580 of the process of FIG. 5. The class score vectors for a class (i.e., all the class score vectors computed for the reference data examples of the class) may be combined (e.g., by taking an average) to obtain a vector of expected class scores for the class. A vector of expected class scores may be created for each class and stored for use by a classifier.

In some implementations, other statistics of class scores may be computed. For example, a standard deviation of all class scores, a vector of standard deviations for each vector of expected class scores, or a covariance matrix for each vector of expected class scores may be computed. These other statistics may also be stored for use by a classifier.

At step 730, input data is received. The input data may be input data corresponding to any appropriate task, such as text-dependent speaker verification.

At step 740, an input vector of class scores is computed using the input data. Each element of the input vector of class scores may indicate a similarity between the input data and a class of the plurality of classes. The input vector of class scores may be computed using any appropriate techniques, such as the scores computed at step 580 of the process of FIG. 5.

At step 750, a classification score is computed for each class of the plurality of classes by comparing the input vector of class scores with the vector of expected class scores for the class. Any appropriate techniques may be used for the comparison. In some implementations, the classification score for a class may be a cosine similarity or cosine distance between the input vector of class scores and the vector of expected class scores for the class. In some implementations, the classification score may by computed as a likelihood of a Gaussian random variable where the mean of the random variable is the vector of expected class scores and variance is any of the variances described above.

At step 760, a class is selected using the classification scores. In some implementations, a class having a highest classification score may be selected. In some implementations, a class having a highest classification score may be selected if another condition is met (e.g., the highest classification score is above a threshold or the distance to the next highest classification score is above a threshold) and no class may be selected if the condition is not met. For example, a speaker may be verified if the highest classification score corresponds to the asserted identity of the unknown speaker.

### Implementation

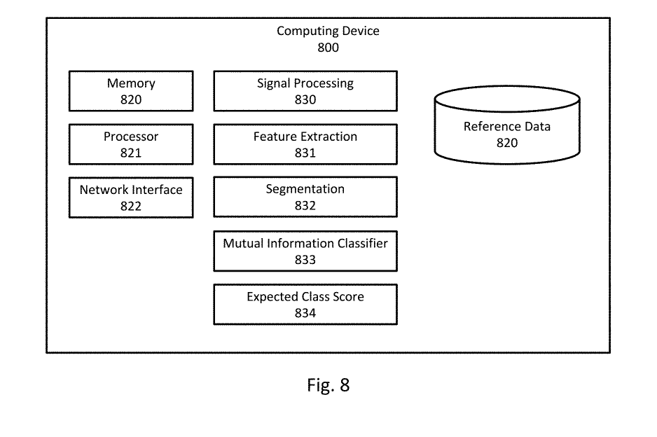

FIG. 8 illustrates components of one implementation of a computing device 800 for implementing any of the techniques described above. In FIG. 8, the components are shown as being on a single computing device 800, but the components may be distributed among multiple computing devices, such as a system of computing devices, including, for example, an end-user computing device (e.g., a smart phone or a tablet) and/or a server computing device (e.g., cloud computing). For example, the collection of audio data and pre-processing of the audio data may be performed by an end-user computing device and other operations may be performed by a server.

Computing device 800 may include any components typical of a computing device, such as volatile or nonvolatile memory 820, one or more processors 821, and one or more network interfaces 822. Computing device 800 may also include any input and output components, such as displays, keyboards, and touch screens. Computing device 800 may also include a variety of components or modules providing specific functionality, and these components or modules may be implemented in software, hardware, or a combination thereof. Below, several examples of components are described for one example implementation, and other implementations may include additional components or exclude some of the components described below.

Computing device 800 may have a signal processing component 830 for performing any needed operations on an input signal, such as analog-to-digital conversion, encoding, decoding, subsampling, or windowing. Computing device 800 may have a feature extraction component 831 that computes feature vectors from audio data or an audio signal. Computing device 800 may have a segmentation component 832 that segments a sequence of feature vectors into a sequence of segments using any of the techniques described above. Computing device 800 may have a mutual information classifier component 833 that classifies input data by computing mutual information between segments of input data and segments of reference data of the classes. Computing device 800 may have an expected class score component 834 that computes vectors of expected class scores for the classes and classifies input data by comparing an input vector of class scores with the vectors of expected class scores. Computing device 800 may have or may have access to one or more data stores, such as a data store of reference data 820 that may be used in classifying input data.

Depending on the implementation, steps of any of the techniques described above may be performed in a different sequence, may be combined, may be split into multiple steps, or may not be performed at all. The steps may be performed by a general purpose computer, may be performed by a computer specialized for a particular application, may be performed by a single computer or processor, may be performed by multiple computers or processors, may be performed sequentially, or may be performed simultaneously.

The techniques described above may be implemented in hardware (e.g., field-programmable gate array (FPGA), application specific integrated circuit (ASIC)), in software, or a combination of hardware and software. The choice of implementing any portion of the above techniques in hardware or software may depend on the requirements of a particular implementation. A software module or program code may reside in volatile memory, non-volatile memory, RAM, flash memory, ROM, EPROM, or any other form of a non-transitory computer-readable storage medium.

Conditional language used herein, such as, “can,” “could,” “might,” “may,” “e.g.,” is intended to convey that certain implementations include, while other implementations do not include, certain features, elements and/or steps. Thus, such conditional language indicates that that features, elements and/or steps are not required for some implementations. The terms “comprising,” “including,” “having,” and the like are synonymous, used in an open-ended fashion, and do not exclude additional elements, features, acts, operations. The term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is to be understood to convey that an item, term, etc. may be either X, Y or Z, or a combination thereof. Thus, such conjunctive language is not intended to imply that certain embodiments require at least one of X, at least one of Y and at least one of Z to each be present.

While the above detailed description has shown, described and pointed out novel features as applied to various implementations, it can be understood that various omissions, substitutions and changes in the form and details of the devices or techniques illustrated may be made without departing from the spirit of the disclosure. The scope of inventions disclosed herein is indicated by the appended claims rather than by the foregoing description. All changes which come within the meaning and range of equivalency of the claims are to be embraced within their scope.

What is claimed is:

1. A computer-implemented method for classifying an input signal, the method comprising:
obtaining an input sequence of feature vectors corresponding to the input signal;
determining an input sequence of segments using the input sequence of feature vectors, wherein each input segment corresponds to a portion of the input sequence of feature vectors;
obtaining a first reference sequence of segments corresponding to a first class;
computing a first matrix of scores using the input sequence of segments and the first reference sequence of segments, wherein:
the size of the first matrix of scores along a first dimension is equal to a number of segments of the input sequence of segments,
the size of the first matrix of scores along a second dimension is equal to a number of segments of the first reference sequence of segments, and
each element of the first matrix of scores comprises a score indicating a similarity between a segment of the input sequence of segments and a segment of the first reference sequence of segments;
computing a first probability mass function using the first matrix of scores, wherein each element of the first probability mass function comprises a probability relating to a segment of the input sequence of segments and a segment of the first reference sequence of segments;
computing a first mutual information value using the first probability mass function;
obtaining a second reference sequence of segments corresponding to the first class;
computing a second matrix of scores using the input sequence of segments and the second reference sequence of segments;
computing a second probability mass function using the second matrix of scores;
computing a second mutual information value using the second probability mass function;
computing a first class score indicating a similarity between the input signal and the first class using the first mutual information value and the second mutual information value; and
selecting a class using the first class score.

2. The method of claim 1, wherein:
the input signal comprises speech;
the first reference sequence of segments was created from a first example of speech of a first user; and
the second reference sequence of segments was created from a second example of speech of the first user.

3. The method of claim 1, wherein computing each element of the matrix of scores comprises:
creating a first vector from feature vectors of a segment of the input sequence of segments;
creating a second vector from feature vectors of a segment of the first reference sequence of segments; and
computing a Pearson's product-moment correlation of the first vector and the second vector.

4. The method of claim 1, wherein computing the first probability mass function using the first matrix of scores comprises:
computing a first Fisher matrix by computing a Fisher transform of each element of the first matrix of scores;
computing a first transformed Fisher matrix by transforming the elements of the first Fisher matrix using an estimated cumulative distribution function; and
computing the first probability mass function using the first transformed Fisher matrix.

5. The method of claim 1, wherein computing the score indicating a similarity between the input signal and the first class comprises computing an average of a plurality of values, wherein the plurality of values comprises the first mutual information value and the second mutual information value.

6. The method of claim 1, wherein selecting a class comprises:
computing a plurality of class scores, where in each class score indicates a similarity between the input signal and a class wherein the plurality of class scores comprises the first class score; and
selecting a class using a largest class score of the plurality of class scores.

7. The method of claim 1, further comprising:
receiving an asserted identity; and
obtaining the first reference sequence of segments using the asserted identity.

8. The method of claim 1, wherein each element of the first matrix of scores is computed by:
aligning an input segment of the input sequence of segments with a reference segment of the first reference sequence of segments; and
computing the score using the aligned input segment and reference segment.

9. A system for classifying an input signal, the system comprising:
one or more computing devices comprising at least one processor and at least one memory, the one or more computing devices configured to:
obtain an input sequence of feature vectors corresponding to the input signal;
determine an input sequence of segments using the input sequence of feature vectors, wherein each input segment corresponds to a portion of the input sequence of feature vectors;
obtain a first reference sequence of segments corresponding to a first class;
compute a first matrix of scores using the input sequence of segments and the first reference sequence of segments, wherein:
the size of the first matrix of scores along a first dimension is equal to a number of segments of the input sequence of segments,
the size of the first matrix of scores along a second dimension is equal to a number of segments of the first reference sequence of segments, and
each element of the first matrix of scores comprises a score indicating a similarity between a segment of the input sequence of segments and a segment of the first reference sequence of segments;
compute a first probability mass function using the first matrix of scores, wherein each element of the first probability mass function comprises a probability relating to a segment of the input sequence of segments and a segment of the first reference sequence of segments;
compute a first mutual information value using the first probability mass function;
obtain a second reference sequence of segments corresponding to the first class;
compute a second matrix of scores using the input sequence of segments and the second reference sequence of segments;
compute a second probability mass function using the second matrix of scores;
compute a second mutual information value using the second probability mass function;
compute a first class score indicating a similarity between the input signal and the first class using the first mutual information value and the second mutual information value; and
select a class using the first class score.

10. The system of claim 9, wherein each feature vector of the input sequence of feature vectors comprises a plurality of harmonic amplitudes.

11. The system of claim 9, wherein the input signal comprises speech and the first class corresponds to speech of a first speaker.

12. The system of claim 9, wherein each segment of the input sequence of segments corresponds to a hyperphoneme.

13. The system of claim 9, wherein each element of the first matrix of scores comprises a correlation between a segment of the input sequence of segments and a segment of the first reference sequence of segments.

14. The system of claim 9, wherein the number of segments of the input sequence of segments is different from the number of segments of the first reference sequence of segments.

15. The system of claim 9, wherein selecting a class comprises comparing first class score to a threshold.

16. One or more non-transitory computer-readable media comprising computer executable instructions that, when executed, cause at least one processor to perform actions comprising:
obtaining an input sequence of feature vectors corresponding to an input signal;
determining an input sequence of segments using the input sequence of feature vectors, wherein each input segment corresponds to a portion of the input sequence of feature vectors;
obtaining a first reference sequence of segments corresponding to a first class;
computing a first matrix of scores using the input sequence of segments and the first reference sequence of segments, wherein:
the size of the first matrix of scores along a first dimension is equal to a number of segments of the input sequence of segments,
the size of the first matrix of scores along a second dimension is equal to a number of segments of the first reference sequence of segments, and
each element of the first matrix of scores comprises a score indicating a similarity between a segment of the input sequence of segments and a segment of the first reference sequence of segments;
computing a first probability mass function using the first matrix of scores, wherein each element of the first probability mass function comprises a probability relating to a segment of the input sequence of segments and a segment of the first reference sequence of segments;
computing a first mutual information value using the first probability mass function;
obtaining a second reference sequence of segments corresponding to the first class;
computing a second matrix of scores using the input sequence of segments and the second reference sequence of segments;
computing a second probability mass function using the second matrix of scores;
computing a second mutual information value using the second probability mass function;
computing a first class score indicating a similarity between the input signal and the first class using the first mutual information value and the second mutual information value; and
selecting a class using the first class score.

17. The one or more non-transitory computer-readable media of claim 16, wherein each element of the first matrix of scores is a Pearson's product-moment correlation of an input segment of the input sequence of segments with a reference segment of the first reference sequence of segments.

18. The one or more non-transitory computer-readable media of claim 16, comprising:
obtaining a first reference signal; and
computing the first reference sequence of segments from the first reference signal.

19. The one or more non-transitory computer-readable media of claim 16, comprising:
computing a class score for each class of a plurality of classes, where in each class score indicates a similarity between the input signal and a class and wherein the plurality of classes comprises the first class;
creating a class score vector from the plurality of class scores;
obtain a plurality of expected class score vectors, wherein:
each expected class score vector corresponds to a class of the plurality of classes, and
each element of each expected class score vector comprises an expected class score between a class corresponding to the expected class score vector and another class; and
selecting a class comprises comparing the class score vector with the plurality of expected class score vectors.

20. The one or more non-transitory computer-readable media of claim 19, wherein comparing the class score vector with an expected class score vector of the plurality of expected class score vectors comprises computing a cosine similarity between the class score vector and the expected class score vector.

21. The one or more non-transitory computer-readable media of claim 16, wherein the first probability mass function is a joint probability mass function or a conditional probability mass function.
